(19) United States
(12) Patent Application Publication
(10) Pub. No.: US 2012/0137941 A1
(43) Pub. Date: Jun. 7, 2012

(54) METHOD FOR ENHANCING HARVEST SECURITY OF CROPS REQUIRING VERNALIZATION

(75) Inventors: Herve R. Vantieghem, Stutensee (DE); Mathis Müller, Barmstedt (DE)

(73) Assignee: BASF SE, Ludwigshafen (DE)

(21) Appl. No.: 13/379,700

(22) PCT Filed: Jun. 11, 2010
(86) PCT No.: PCT/EP2010/058204

§ 371 Date: Dec. 21, 2011

(30) Foreign Application Priority Data
Jun. 22, 2009 (EP) 09163376.8

(51) Int. Cl. A01C 7/08

(52) U.S. Cl. 111/100

(57) ABSTRACT

The present invention relates to a method for enhancing harvest security of crops needing vernalization comprising the steps: a) advanced seeding of a crop variety before seeding of such crop variety is generally carried out in the respective area, and b) applying a mixture comprising at least two active compounds (A) selected from the group consisting of mepiquat chloride, chlormequat chloride, N,N-dimethylmorpholinium chloride, metconazole, tebuconazole, paclobutrazol, trinexapac and prohexadion or an agriculturally useful salt thereof to the crop variety seeded according to step a). In addition, the invention relates to the use of a mixture comprising at least two active compounds (A) selected from mepiquat chloride, chlormequat chloride, N,N-dimethylmorpholinium chloride, metconazole, tebuconazole, paclobutrazol, trinexapac and prohexadion or an agriculturally useful salt thereof for enhancing harvest security of crops needing vernalization.

The present invention relates to a method for enhancing harvest security of crops needing vernalization comprising the steps:

a) advanced seeding of a crop variety before seeding of such crop variety is generally carried out in the respective area, and

b) applying a mixture comprising at least two active compounds (A) selected from the group consisting of mepiquat chloride, chlormequat chloride, N,N-dimethylmorpholinium chloride, metconazole, tebuconazole, paclobutrazol, trinexapac and prohexadion or an agriculturally useful salt thereof to the crop variety seeded according to step a).

In addition, the invention relates to the use of a mixture comprising at least two active compounds (A) selected from mepiquat chloride, chlormequat chloride, N,N-dimethylmorpholinium chloride, metconazole, tebuconazole, paclobutrazol, trinexapac and prohexadion or an agriculturally useful salt thereof for enhancing harvest security of crops needing vernalization.

Bioregulatory active ingredients which are employed in the field of agriculture are, inter alia, quaternized compounds amongst which the most important representatives are N,N,N-trimethyl-N-β-chloroethylammonium chloride (CCC, chlorcholine chloride, chlormequat chloride, DE 12 94734), N,N-dimethylmorpholinium chloride (DMC, DE 16 42 215) and N,N-dimethylpiperidinium chloride (DPC, MQC, mepiquat chloride, DE 22 07575). These active ingredients, in particular chlormequat chloride and mepiquat chloride, are typically employed in the production of cereals and cotton at comparatively high dosage rates. The application rate of these active ingredients amounts, as a rule, to 0.3-1.5 l/ha per application. The products are commercially available for example as aqueous active ingredient concentrates (for example Cycocel®, Terpal® and Pix® brands (mixtures with ethephon) in the form of SL mixtures, BASF SE).

Triazoles are an important class of active ingredients in the pesticide field. As ergosterol biosynthesis inhibitors, they are primarily employed as fungicides (see, for example, DE 195 20 935 A1). Some triazoles are also employed as plant growth regulators. In addition, various of the triazoles which, as such, have fungicidal activity are occasionally also described as having plant-growth regulatory properties (see, for example, EP 0040345 A1; EP 0057 357 A1). Thus, paclobutrazole and uniconazole inhibit gibberellin biosynthesis and thus cell elongation and cell division.

WO 04/023875 relates to agents containing carboxylic acid and based on active ingredients which have a bioregulatory action and are from the class of triazoles, and to the use of the same as bioregulators in plant cultivation.

The active ingredients from the class of the quaternized ammonium compounds can be employed together with other bioregulatory active compounds. For example, EP 0 344 533 describes synergistic combinations with growth-regulatory 3,5-dioxo-4-propionyl-cydohexanecarboxylic acid derivatives such as prohexadione-calcium. DE 43 00 452 A1 proposes to employ CCC together with tebuconazole or triadimefon for inhibiting plant growth. The use of uniconazole together with CCC is described in EP 287 787 A1 for regulating plant growth. Other important ergosterol biosynthesis inhibitors can be found among the morpholine fungicides e.g. dimethomorph ((E,Z) 4[-3-(4-chlorophenyl)-3-(3,4-dimethoxyphenyl)-1-oxo-2-propenyl]morpholine; DMM; described in EP 120321) which is known to control oomycetes diseases. Dimethomorph is sold in Europe under the trade names Forum® and Acrobat®.

Amides are known as fungicides (cf., for example, EP-A 545099, EP-A 589301, EP-A 737682, EP-A 824099, WO 99/09013, WO 03/010149, WO 03/070705, WO 03/074491, WO 2004/005242, WO 04/035589, WO 04/067515, WO 06/087343). They can be prepared in the manner described therein. Combinations of amides with fungicides are disclosed in WO 07/017416, PCT/EP2008/051331, PCT/EP2008/051375, WO 08/000377, WO 07/128756, WO 09/106633, WO 09/135834, WO 09/056620 and WO 08/113654.

The further active ingredients as well as their pesticidal or plant growth regulatory action and methods for producing them are generally known. For instance, the commercially available compounds may be found in The Pesticide Manual, 14th Edition, British Crop Protection Council (2006) among other publications.

Even though the above defined compounds are known to be applied for either reducing the disease pressure or influencing the general growth of plants, it is unknown to date that they may be used for enhancing the harvest security of crops requiring vernalization within a complex growing system.

WO 02/083732 relates to the use of specific quaternized bioregulatory active ingredients in combination with triazole derivatives, in particular metconazole or an agriculturally utilizable salt thereof. The patent application discloses the fact that by applying said mixture, the vegetative growth of the shoot of plants is inhibited while at the same time the root growth is increased. In addition, WO 02/083732 describes various advantages that derive from the use of the claimed mixtures such as an increase in the standing ability of crops which are prone to lodging under adverse weather conditions, the possibility to modify the course of maturation over time in cotton making completely automated harvesting of cotton feasible, increased frost hardness, denser planting of crop plants so that higher yields based on the acreage can be achieved, shortened or extended developmental stages or else an acceleration or delay in maturity of the harvested plant parts pre- or postharvest, dehiscence or reduced adhesion of fruits to the tree in the case of citrus fruit, olives or in other varieties and cultivars of pome fruit, stone fruit and shelled fruit or a reduction in the water consumption of plants. A particular subject matter of the invention disclosed by WO 02/083732 is the use of said mixture for improving root growth. The purpose of this use is predominantly the development of an increased number of root branches, longer roots and/or an increased root surface area. This improves the water and nutrient uptake capacity of the plants. In autumn, a larger storage root is formed in particular in winter oilseed rape to allow for more intense new growth in spring.

However, WO 02/083732 remains silent with respect to a method for enhancing harvest security of crops requiring vernalization using specific mixtures within a complex growing system. In addition, no hints are given towards an advanced seeding (earlier seeding) of crops requiring vernalization.

As a result, the foregoing documents fail to teach or suggest the present invention.

During the life cycle of a crop plant, which starts with its germination and typically ends with its harvest, the plant undergoes various unpredictable threats which may result in a reduced yield or in the worst case in a complete loss of harvest. Depending on the location where the crop plants are grown, the weather in the respective region and the occurrence of pests such as weeds, grasses, phytopathogenic fungi, bacteria, virus or insects harming the plants, the final yield will vary significantly from year to year leading to great uncertainty for the farmer.

One of the key decisions in the year of seeding that affects the harvest security and consequently the final yield of crops requiring vernalization is their seeding date. Many factors have to be considered such as weather, the impact of weeds, soil temperature, soil preparation, frost concerns and potential pest infestation.

In addition, the seeding date is important because it is one of the parameters that directly influences the stage of plant development in which the plant will enter into the winter. In order to achieve maximum cold tolerance, healthy, vigorous plants must be established prior to winter and especially before the first frost because the stage of plant development that a plant has reached prior to winter also impacts the agronomic performance of the crop during the growing season directly following the winter.

Any crop has an optimal seeding time point. It is well known to the person skilled in the art, that the optimal seeding time point depends on many parameters. One of them is the region where the seeding takes place (subsequently referred to as the “respective area”). However, the optimal seeding time point strongly depends on various other parameters such as the cultivated crop (whether for example winter oilseed rape or winter barley are grown), the specific crop variety (for example whether a line variety, semi dwarf variety or hybrid variety is grown), the specific location where the plants are grown or which agricultural technique is used (for example whether reduced tillage systems are applied).

Optimum seeding dates for crops requiring vernalization vary from crop to crop and from area to area. Even though the calculated optimal seeding dates based on empiric data are known to the person skilled in the art, the actual seeding date may differ due to external factors.

In the current application, the terms “advanced seeding” and “early seeding” are used as synonyms.

Although there has been substantial interest in late seeding, early seeding offers manifold advantages. One potential benefit of early seeding is the fact that the sowing conditions at an advanced time point are generally better compared to late seeding. This is especially true with respect to the soil water content (humidity), the amount of available oxygen and the still higher soil temperatures compared to conditions that can be found at late seeding. Vice versa late seeding always brings about the danger that the plants will not germinate properly due to too dry soils, lack of oxygen and increasingly low soil temperatures depending on the date and year.

Good germination leads to better emergence conditions and crop establishment based on a more developed root system which in turn results in a better uptake of nutrients and water, giving the young crops an optimal start. Due to the more developed root system, plants seeded early can often make use of the possibility of an better and higher nitrogen uptake throughout autumn by which the loss of nitrate is reduced (less leaching). This has not only economic benefits (nitrogen is very important for the plant's growth and yield and is an important cost factor in the production of the crop) but also helps to reduce environmental damages such as the contamination of ground water. Consequently, early seeding and the improved uptake of nitrogen by the growing crop plant has clear environmental and economic advantages.

Another advantage of early seeding of crops requiring vernalization is the fact that the plants have more time to germinate, to emerge and finally to develop until winter comes. While late seeding always is combined with the risk that the plants will not properly germinate, emerge and grow, early sowing will eventually overrule bad growing conditions because the plants have enough time to recover from intermittent less optimal growing conditions making use of favorable growing conditions over a longer period of time prior to the start of winter. Consequently, early seeding results in a significant increase in growing, crop development and harvest security.

Yet another advantage of early seeding is its applicability within reduced tillage systems. During the last years there is an increasing trend towards reduced tillage which is characterized by less workload and reduced costs for soil and sowing preparations. However, reduced tillage is generally associated with a slower and retarded emergence and crop development. Therefore, earlier seeding can overcome this disadvantage of reduced tillage.

Late seeding can result in significant yield reduction, delayed heading, later maturity, lower bushel weights and increased problems with weeds, grasses and other crop pests such as insects and disease organisms. With respect to disease control, early seeding displays additional advantages. For example in the struggle with weeds, early seeded crop plants are more competitive than the respective plants seeded at a later stage, simply because they are bigger, stronger, more vital and because they close faster their canopy. This can also be observed with respect to slugs. Based on the additional biomass resulting from an early seeding, slug damage has a smaller impact since the crop has more biomass left to recover after the slug attack.

It has also been reported, that early seeding results in floral initiation and an earlier start of flowering. As a result, the respective crop plants may better use favorable weather conditions and have more time in the year of harvest to develop seeds. In addition, a more homogenous maturation of the seeds can be assured.

The final result of early seeding is an increase in yield which may be based on larger pods and an increased seed number per pod for instance for winter oilseed rape. Probably the most important overall gain is, however, the high consistency with which the farmer can rely on a successful and reproductive harvest, resulting an increased harvest security.

With respect to the work load of the farmer, early seeding leads to a separation in time of the manifold work related to other crops grown in parallel which also needs to be carried out during the vegetation cycle. Consequently, earlier seeding results in an increase in work load flexibility and therefore, security, for the farmer.

The main disadvantage of early seeding is the risk that the crop overgrows. This typically happens in case of too favorable, such as growth promoting and/or longer, growing conditions for the crop. Too vigorous growth before winter results in plants that exhibit too much shoot elongation, foliage and consequently too much total plant biomass before the start of winter.

One of the key problems arising out of such overgrown plants is their reduced frost hardness. In case these plants are struck by a harsh and/or long winter, the likelihood of severe crop damage and thereof yield losses is high. Crops requiring vernalization should neither have too much foliage nor shoot elongation prior to the onset of winter. Consequently, the crop remains close to the ground and is less vulnerable to cold winds during late autumn and winter. In addition, the low canopy of the crop can also be sheltered against cold and freezing conditions by snow cover. It is generally known to the person skilled in the art that the seeding date has a big impact on the crop's winter survival potential. Seeding too early or too late will reduce winter hardiness and therefore bears the risk that the predicted yield of the crop will not be attained. While too early seeding can result in excessive growth in the fall leading to plants that are less resistant to winter injury, late dates of seeding bear the risk of an insufficient and poor establishment of the crop before the start of the winter and a subsequent disappointing yield.

The risk of overgrowing plants is especially critical for most hybrid varieties such as for instance hybrid varieties of winter oilseed rape. This fact is especially critical considering the clear trend (especially with respect to winter oilseed rape) towards vigorous, powerful hybrid varieties with a high yield potential. Besides others, hybrid varieties are known for their strong development, their robustness even under bad weather conditions or suboptimal soil conditions and their high superior root system leading to higher yields compared to non-hybrid varieties. However, due to their vigorous growth behavior and fast development, the risk of overgrowing and consequent winter damages is very high. To avoid severe yield losses, hybrid varieties are therefore seeded rather late under current practice.

When applying plant protection compounds for example in the form of seed treatment, the risk of overgrowing before the start of winter is even more severe because the plants will remain healthier, more vital and will consequently display an even more vigorous growth. While the treatment is necessary to overcome the threat of pests attacking the crop, it may indirectly enhances the risk of overgrowing the crop. A typical example is the compound dimethomorph (DMM) which is preferably used as seed treatment against powdery mildew but which has the disadvantage of acting as a plant vitalizing compound accelerating the growth and development of young plants and therefore, sustaining the risk of overgrowing the crop. Consequently, dimethomorph or other compounds exhibiting comparable growth enhancing properties can currently not be used by the farmer neither to protect the crop against diseases nor to safeguard its yield without risking the above defined disadvantages.

As a consequence, if dimethomorph or other compounds exhibiting similar growth enhancing properties are used, good growing hybrid varieties can often not be sown early, and their high yield potential can not be exploited due to the above described side effects of such compounds.

As pointed out above, early seeding may advance the time of floral initiation resulting in an earlier start of flowering. Even though, this is regarded as a big advantage, too early flowering, as for instance by winter oilseed rape, can lead to a too abundant flowering with less light penetration and thereof a reduced seed number per pod despite the initially favorable higher pod numbers.

Earlier seeding results in an improved uptake of nitrogen and enhanced plant growth throughout autumn. However, while this is generally regarded as an advantage, the increase in foliage bears the risk of overgrowing and frost damage.

In addition, due to early seeding, typically an increased disease pressure can be observed because the phytopathogenic fungi have more time to develop.

As described above, the final yield of crops needing vernalization depends on multiple factors and is highly unpredictable. Besides the choice of a crop variety suitable for the respective area, biotic and abiotic factors have a big impact on the plant's development during the vegetation cycle and may constitute a severe threat to the plant, often resulting in a significant reduced yield. Consequently, the farmer finds himself in a situation unable to attain his predicted yield and/or harvest time point. Accordingly, there is a constant need for increasing the ability to plan and control factors influencing harvest security for farmers. To reduce the risk of a failed harvest, the factors determining the yield have to be constantly and best possible controlled during the vegetation cycle and those factors having a negative impact on the yield have to minimized.

It was therefore an object of the present invention to provide a method which solves the problems outlined above, and which should, in particular, improve harvest security.

We have found that this object is achieved by the method defined at the outset comprising the advanced seeding of a crop variety before seeding of such crop variety is generally carried out in the respective area and subsequently applying at least two active compounds (A) selected from the group consisting of mepiquat chloride, chlormequat chloride, N,N-dimethylmorpholinium chloride, metconazole, tebuconazole, paclobutrazol, trinexapac and prohexadion or an agriculturally useful salt thereof to the crop needing vernalization.

The method according to the invention as well as its use has advantages over the currently applied methods in plant production, especially with respect to crops needing vernalization.

Due to the method according to the invention, the practitioner such as a farmer has obtained a method that gives him the possibility to manage and control the time point and quantity of growth of the crop plants which in turn makes it possible to optimize the development of such crops (e.g. prior to the start of winter) depending on the present abiotic and biotic conditions that strongly influence growth. Based on the early seeding and in combination with the targeted application of the mixtures according to the invention, the farmer can now fine tune and manage the growth and the development of the crop. As a consequence, it is now possible to control the plant development all over the vegetation cycle making it possible that the crops needing vernalization pass the winter in their optimal growing stage avoiding potential winter damage and subsequently yield losses. In addition, the farmer can continue to adjust the growth of the plants in their second year of the vegetation cycle following winter in a way that the harvest time point can be more reliably estimated. As a result, the intended harvest time point may be met as well as the predicted yield obtained—both key parameters of harvest security.

Consequently, in one embodiment of the invention, the method according to the invention leads to an enhancement of harvest security, which is manifested in a increased reliability of the expected yield.

Even high potential varieties of a crop needing vernalization not yet adopted for the respective region may be grown which was not possible before. Furthermore, the method according to the invention helps to address errors of farmers who purchased crop varieties not recommended and/or adapted for the respective area.

When early seeding is carried out using hybrid varieties that need vernalization, the farmer currently has to risk various disadvantages. Such big disadvantages are the risk of overgrowing crops and consequently, among others, severe frost damages leading to great uncertainty with respect to harvest security such as the expected final yield. Applying the method according to the invention, however, gives the farmer a tool and therefore the possibility to control too vigorous growth, which is typical for all hybrid varieties especially under favorable weather conditions. As a result, the farmer has finally the chance to take benefit from all advantages of early seeding while at the same time being able to grow the advantageous hybrid varieties.

Another advantage of the method according to the invention are considerably lower application rates of the compounds applied. As a consequence, potential crop damage due to too high dose rates of certain plant growth regulators can be avoided. Consequently, early seeding can be managed in an economic and ecologically friendly way resulting in an increased harvest security manifested in more reliable yields. So far no suitable method is available to the practitioner.

Using the method according to the invention, results in higher flexibility with respect to the time point of seeding and harvesting; early seeding being typically preferred. Since weather can not be reliably predicted, it is important for the farmer to be able to vary the seeding and harvesting point. Especially when bad weather is forecasted for the optimal seeding time point, an advanced seeding may be of big advantage. However, too favorable weather conditions may have been on obstacle for advanced seeding, too, due to the risk of overgrowing of the respective crop. By applying the method according to the invention, early seeding is now surprisingly possible without risking the problems described above. This harvest security in turn results in a huge flexibility of the farmer.

In one embodiment of the invention, the method according to the invention leads to an enhancement of harvest security, which is manifested in a more equally distributed work load during harvest time.

Due to the application of pesticides, which keep plants healthier and as a result delay maturation and harvest time, and due the increased use of various new varieties, more crop plants are currently ready for harvest at the same time which imposes a huge problem for the practitioner. Using the method according to the invention, however, the maturation of each individual cultivated crop species can be specifically controlled (advanced or delayed) allowing a consecutive harvest which in turn increases the overall harvest security.

In another embodiment of the invention, the method according to the invention leads to an enhancement of harvest security, which is manifested in a more predictable harvesting time point

Early seeding results in an improved uptake of nitrogen which in turn leads to more foliage and shoot elongation with the risk of overgrowing prior to the start of winter and frost damage. However, when combining early seeding with the application of at least two compounds (A), shoot elongation, overgrowing and consequently severe frost damages can be avoided.

As pointed out above, early seeding may also advance the time of floral initiation resulting in an earlier start of flowering. Even though, this is regarded as a big advantage, too early flowering, for instance in the case of winter oilseed rape, can lead to a too abundant flowering with less light penetration and a reduced seed number per pod despite the initially favorable higher pod number. However, when combining early seeding with the application of a least two compounds (A), too abundant flowering can be avoided.

Yet another advantage of the current inventions is the reduction of damage by phytopathogenic fungi. At a time when the weather is often favorable for an infestation by various phytopathogenic fungi, the combination of early seeding and the application of at least two compounds (A) results in plants that have reached an developmental stage, in which their root base is thicker and more pronounced, which makes them less prone to infestations of phytopathogenic fungi such as phoma.

As mentioned at the outset, the present invention relates to a method for enhancing harvest security of crops requiring vernalization, which method comprises applying to the plants a mixture comprising at least two active compounds (A) selected from mepiquat chloride, chlormequat chloride, N,N-dimethylmorpholinium chloride, metconazole, tebuconazole, paclobutrazol, trinexapac and prohexadion or an agriculturally useful salt thereof.

In one embodiment, the mixture comprises at least two compounds (A) selected from: mepiquat chloride, chlormequat chloride, N,N-dimethylmorpholinium chloride, metconazole, tebuconazole, paclobutrazol, trinexapac and prohexadion or an agriculturally useful salt thereof.

In another embodiment, the mixture comprises at least two compounds (A) selected from mepiquat chloride, chlormequat chloride, metconazole, tebuconazole, paclobutrazol or an agriculturally useful salt thereof.

Preferably, the mixture according to the invention comprises as compounds (A) mepiquat chloride and metconazole.

Thus, with respect to their intended use in the methods of the present invention, the following secondary mixtures listed in table 1 comprising two compounds (A) are a preferred embodiment of the present invention.

In another embodiment, the present invention relates to a method for enhancing harvest security of crops requiring vernalization, which method comprises applying in step b) to the plants at least one mixture as defined in table 1.

TABLE 1

| No. | Compound (A1) | Compound (A2) |
|---|---|---|
| M-1 | Mepiquat-chloride | Metconazole |
| M-2 | Mepiquat-chloride | Tebuconazole |
| M-3 | Mepiquat-chloride | Paclobutrazole |
| M-4 | Mepiquat-chloride | Trinexapac |
| M-5 | Mepiquat-chloride | Prohexadione |
| M-6 | Chlormequat- | Metconazole |
| | chloride | |
| M-7 | Chlormequat- | Tebuconazole |
| | chloride | |
| M-8 | Chlormequat- | Paclobutrazole |
| | chloride | |
| M-9 | Chlormequat- | Trinexapac |
| | chloride | |
| M-10 | Chlormequat- | Prohexadione |
| | chloride | |
| M-11 | Trinexapac | Metconazole |
| M-12 | Trinexapac | Tebuconazole |
| M-13 | Trinexapac | Paclobutrazole |
| M-14 | Trinexapac | Prohexadione |
| M-15 | Prohexadione | Metconazole |
| M-16 | Prohexadione | Tebuconazole |
| M-17 | Prohexadione | Paclobutrazole |

Within the mixtures of table 1, the following mixtures are preferred: M-1, M-2, M-3, M-4, M-5, M-6, M-7, M-8, M-9 and M-10. Within this subset, the following mixtures are especially preferred: M-1, M-2, M-3, M-4, M-5, M-6, M-7 and M-8. Within this subset, the following mixtures are even more preferred: M-1, M-2, M-6 and M7. Utmost preference is given to mixture M1.

With respect to their intended use within the methods of the present invention, the following ternary mixtures listed in table 2, comprising three compounds (A) are a preferred embodiment of the present invention.

TABLE 2

| No. | Compound (A1) | Compound (A2) | Compound (A3) |
|---|---|---|---|
| N-1 | Mepiquat-chloride | Metconazole | Trinexapac |
| N-2 | Mepiquat-chloride | Metconazole | Prohexadione |
| N-3 | Mepiquat-chloride | Tebuconazole | Trinexapac |
| N-4 | Mepiquat-chloride | Tebuconazole | Prohexadione |
| N-5 | Mepiquat-chloride | Paclobutrazol | Trinexapac |
| N-6 | Mepiquat-chloride | Paclobutrazol | Prohexadione |
| N-7 | Chlormequat | Metconazole | Trinexapac |
| N-8 | Chlormequat | Metconazole | Prohexadione |
| N-9 | Chlormequat | Tebuconazole | Trinexapac |
| N-10 | Chlormequat | Tebuconazole | Prohexadione |
| N-11 | Chlormequat | Paclobutrazol | Trinexapac |
| N-12 | Chlormequat | Paclobutrazol | Prohexadione |

Within the ternary mixtures of table 2, the following mixtures are preferred according to the present invention: N-1, N-2, N-3, N-4, N-5, N-6, N-7, N-9 and N-11.

Within the ternary mixtures of table 2, the following mixtures are more preferred according to the present invention: N-1, N-3, N-5, N-7, N-9 and N-11.

Within the ternary mixtures of table 2, the following mixtures are especially preferred according to the present invention: N-1, N-3, N-5 and N-9.

In another embodiment, the present invention relates to a method for enhancing harvest security of crops requiring vernalization, which method comprises applying to the plants a mixture comprising:

(1) two active compounds (A) selected from the group consisting of mepiquat chloride, chlormequat chloride, N,N-dimethylmorpholinium chloride, metconazole, tebuconazole, paclobutrazol, trinexapac and prohexadion or an agriculturally useful salt thereof and

(2) one compound (B), wherein compound (B) is a fungicide selected from the groups consisting of

(i) strobilurines, selected from azoxystrobin, dimoxystrobin, fluox-astrobin , kresoxim-methyl, metominostrobin, orysastrobin, picoxystrobin, pyraclostrobin and trifloxystrobin;

(ii) carboxylic amides, selected from N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, N-(3′,4′-dichloro-5-fluorobiphenyl-2-yl)-3-difluoromethyl-1-methylpyrazole-4-carboxamide (common name: bixafen), N-[2-(1,3-dimethylbutyl)-phenyl]-1,3-dimethyl-5-fluoro-1H-pyrazole-4-carboxamide, N-(2-bicyclopropyl-2-yl-phenyl)-3-difluoromethyl-1-methyl-1H-pyrazole-4-carboxamide (common name: sedaxane), N-[1,2,3,4-tetrahydro-9-(1-methylethyl)-1,4-methanonaphthalen-5-yl]-3-(difluoromethyl)-1-methyl-1H-pyrazole-4-carboxamide (common name: isopyrazam) and N-[2-(1,3-dimethylbutyl)-3-thienyl]-1-methyl-3-(trifluoromethyl)-1H-pyrazole-4-carboxamide (common name: penthiopyrad), boscalid, fenhexamid, metalaxyl, di-methomorph, fluopicolide (picobenzamid), zoxamide, mandipropamid and carpropamid;

(iii) azoles, selected from cyproconazole, difenoconazole, epoxiconazole, flusilazole, fluquinconazole, flutriafol, ipconazole, metconazole, propiconazole, prothioconazole, tebuconazole, cyazofamid, prochloraz, ethaboxam and triazoxide;

(iv) heterocyclic compounds, selected from famoxadone, fluazinam, cyprodinil, pyrimethanil, fenpropimorph, iprodione, acibenzolar-S-methyl, proquinazid, quinoxyfen, fenpiclonil, captan, fenpropidin, captafol and anilazin;

(v) carbamates and dithiocarbamates, selected from mancozeb, metiram, iprovalicarb, maneb, propineb, flubenthiavalicarb (benthiavalicarb) and propamocarb;

(vi) organo-chloro compounds, selected from thiophanate-methyl, chlorothalonil, tolylfluanid, carbendazim and flusulfamid;

(vii) inorganic active ingredients, selected from Bordeaux composition, copper acetate, copper hydroxide, copper oxychloride, basic copper sulfate and sulfur;

(viii) various, selected from spiroxamine, guazatin, cymoxanil, cyflufenamid, valiphenal, metrafenone; fosetly-aluminium and dithianon.

With respect to their intended use within the methods of the present invention, the following ternary mixtures listed in table 3, comprising two compounds (A) and as a third component one compound (B) are a preferred embodiment of the present invention, especially related to winter oilseed rape.

TABLE 3

| No. | Compound (A1) | Compound (A2) | Compound (B) |
|---|---|---|---|
| O-1 | Mepiquat-chloride | Metconazole | Boscalid |
| O-2 | Mepiquat-chloride | Metconazole | Dimoxystrobin |
| O-3 | Mepiquat-chloride | Metconazole | Difenoconazole |
| O-4 | Mepiquat-chloride | Metconazole | Prothioconazole |
| O-5 | Mepiquat-chloride | Metconazole | Prochloraz |
| O-6 | Mepiquat-chloride | Metconazole | Thiophanate-methyl |
| O-7 | Mepiquat-chloride | Metconazole | Iprodione |
| O-8 | Chlormequat | Metconazole | Boscalid |
| O-9 | Chlormequat | Metconazole | Dimoxystrobin |
| O-10 | Chlormequat | Metconazole | Difenoconazole |
| O-11 | Chlormequat | Metconazole | Prothioconazole |
| O-12 | Chlormequat | Metconazole | Prochloraz |
| O-13 | Chlormequat | Metconazole | Thiophanate-methyl |
| O-14 | Chlormequat | Metconazole | Iprodione |
| O-15 | Trinexapac | Metconazole | Boscalid |
| O-16 | Trinexapac | Metconazole | Dimoxystrobin |
| O-17 | Trinexapac | Metconazole | Difenoconazole |
| O-18 | Trinexapac | Metconazole | Prothioconazole |
| O-19 | Trinexapac | Metconazole | Prochloraz |
| O-20 | Trinexapac | Metconazole | Thiophanate-methyl |
| O-21 | Trinexapac | Metconazole | Iprodione |
| O-22 | Prohexadione | Metconazole | Boscalid |
| O-23 | Prohexadione | Metconazole | Dimoxystrobin |
| O-24 | Prohexadione | Metconazole | Difenoconazole |
| O-25 | Prohexadione | Metconazole | Prothioconazole |
| O-26 | Prohexadione | Metconazole | Prochloraz |
| O-27 | Prohexadione | Metconazole | Thiophanate-methyl |
| O-28 | Prohexadione | Metconazole | Iprodione |
| O-29 | Mepiquat-chloride | Tebuconazole | Boscalid |
| O-30 | Mepiquat-chloride | Tebuconazole | Dimoxystrobin |
| O-31 | Mepiquat-chloride | Tebuconazole | Difenoconazole |
| O-32 | Mepiquat-chloride | Tebuconazole | Prothioconazole |
| O-33 | Mepiquat-chloride | Tebuconazole | Prochloraz |
| O-34 | Mepiquat-chloride | Tebuconazole | Thiophanate-methyl |
| O-35 | Mepiquat-chloride | Tebuconazole | Iprodione |
| O-36 | Chlormequat | Tebuconazole | Boscalid |
| O-37 | Chlormequat | Tebuconazole | Dimoxystrobin |
| O-38 | Chlormequat | Tebuconazole | Difenoconazole |
| O-39 | Chlormequat | Tebuconazole | Prothioconazole |
| O-40 | Chlormequat | Tebuconazole | Prochloraz |
| O-41 | Chlormequat | Tebuconazole | Thiophanate-methyl |
| O-42 | Chlormequat | Tebuconazole | Iprodione |
| O-43 | Trinexapac | Tebuconazole | Boscalid |
| O-44 | Trinexapac | Tebuconazole | Dimoxystrobin |
| O-45 | Trinexapac | Tebuconazole | Difenoconazole |
| O-46 | Trinexapac | Tebuconazole | Prothioconazole |
| O-47 | Trinexapac | Tebuconazole | Prochloraz |
| O-48 | Trinexapac | Tebuconazole | Thiophanate-methyl |
| O-49 | Trinexapac | Tebuconazole | Iprodione |
| O-50 | Prohexadione | Tebuconazole | Boscalid |
| O-51 | Prohexadione | Tebuconazole | Dimoxystrobin |
| O-52 | Prohexadione | Tebuconazole | Difenoconazole |
| O-53 | Prohexadione | Tebuconazole | Prothioconazole |
| O-54 | Prohexadione | Tebuconazole | Prochloraz |
| O-55 | Prohexadione | Tebuconazole | Thiophanate-methyl |
| O-56 | Prohexadione | Tebuconazole | Iprodione |
| O-57 | Mepiquat-chloride | Paclobutrazole | Boscalid |
| O-58 | Mepiquat-chloride | Paclobutrazole | Dimoxystrobin |
| O-59 | Mepiquat-chloride | Paclobutrazole | Difenoconazole |
| O-60 | Mepiquat-chloride | Paclobutrazole | Prothioconazole |
| O-61 | Mepiquat-chloride | Paclobutrazole | Prochloraz |
| O-62 | Mepiquat-chloride | Paclobutrazole | Thiophanate-methyl |
| O-63 | Mepiquat-chloride | Paclobutrazole | Iprodione |
| O-64 | Chlormequat | Paclobutrazole | Boscalid |
| O-65 | Chlormequat | Paclobutrazole | Dimoxystrobin |
| O-66 | Chlormequat | Paclobutrazole | Difenoconazole |
| O-67 | Chlormequat | Paclobutrazole | Prothioconazole |
| O-68 | Chlormequat | Paclobutrazole | Prochloraz |
| O-69 | Chlormequat | Paclobutrazole | Thiophanate-methyl |
| O-70 | Chlormequat | Paclobutrazole | Iprodione |
| O-71 | Trinexapac | Paclobutrazole | Boscalid |
| O-72 | Trinexapac | Paclobutrazole | Dimoxystrobin |
| O-73 | Trinexapac | Paclobutrazole | Difenoconazole |
| O-74 | Trinexapac | Paclobutrazole | Prothioconazole |
| O-75 | Trinexapac | Paclobutrazole | Prochloraz |
| O-76 | Trinexapac | Paclobutrazole | Thiophanate-methyl |
| O-77 | Trinexapac | Paclobutrazole | Iprodione |
| O-78 | Prohexadione | Paclobutrazole | Boscalid |
| O-79 | Prohexadione | Paclobutrazole | Dimoxystrobin |
| O-80 | Prohexadione | Paclobutrazole | Difenoconazole |
| O-81 | Prohexadione | Paclobutrazole | Prothioconazole |
| O-82 | Prohexadione | Paclobutrazole | Prochloraz |
| O-83 | Prohexadione | Paclobutrazole | Thiophanate-methyl |
| O-84 | Prohexadione | Paclobutrazole | Iprodione |
| O-85 | Mepiquat-chloride | Trinexapac | Boscalid |
| O-86 | Mepiquat-chloride | Trinexapac | Dimoxystrobin |
| O-87 | Mepiquat-chloride | Trinexapac | Difenoconazole |
| O-88 | Mepiquat-chloride | Trinexapac | Prothioconazole |
| O-89 | Mepiquat-chloride | Trinexapac | Prochloraz |
| O-90 | Mepiquat-chloride | Trinexapac | Thiophanate-methyl |
| O-91 | Mepiquat-chloride | Trinexapac | Iprodione |
| O-92 | Mepiquat-chloride | Prohexadione | Boscalid |
| O-93 | Mepiquat-chloride | Prohexadione | Dimoxystrobin |
| O-94 | Mepiquat-chloride | Prohexadione | Difenoconazole |
| O-95 | Mepiquat-chloride | Prohexadione | Prothioconazole |
| O-96 | Mepiquat-chloride | Prohexadione | Prochloraz |
| O-97 | Mepiquat-chloride | Prohexadione | Thiophanate-methyl |
| O-98 | Mepiquat-chloride | Prohexadione | Iprodione |
| O-99 | Chlormequat | Trinexapac | Boscalid |
| O-100 | Chlormequat | Trinexapac | Dimoxystrobin |
| O-101 | Chlormequat | Trinexapac | Difenoconazole |
| O-102 | Chlormequat | Trinexapac | Prothioconazole |
| O-103 | Chlormequat | Trinexapac | Prochloraz |
| O-104 | Chlormequat | Trinexapac | Thiophanate-methyl |
| O-105 | Chlormequat | Trinexapac | Iprodione |
| O-106 | Chlormequat | Prohexadione | Boscalid |
| O-107 | Chlormequat | Prohexadione | Dimoxystrobin |
| O-108 | Chlormequat | Prohexadione | Difenoconazole |
| O-109 | Chlormequat | Prohexadione | Prothioconazole |
| O-110 | Chlormequat | Prohexadione | Prochloraz |
| O-111 | Chlormequat | Prohexadione | Thiophanate-methyl |
| O-112 | Chlormequat | Prohexadione | Iprodione |

All mixtures set forth above are also an embodiment of the present invention.

Within the ternary mixtures of table 3, the following mixtures are preferred according to the present invention: O-1, O-2, O-3, O-4, O-5, O-6, O-7, O-8, O-9, O-10, O-11, O-12, O-13, O-14, O-29, O-30, O-31, O-32, O-33, O-34, O-35, O-36, O-37, O-38, O-39, O-40, O-41, O-42, O-57, O-58, O-59, O-60, O-61, O-62, O63, O-64, O-65, O-66, O-67, O-68, O-69 and O-70.

Within the ternary mixtures of table 3, the following mixtures are more preferred according to the present invention: O-1, O-2, O-3, O-4, O-5, O-8, O-9, O-10, O-11, O-12, O-29, O-30, O-31, O-32, O-33, O-36, O-37, O-38, O-39, O-40, O-57, O-58, O-59, O-60, O-61, O-64, O-65, O-66, O-67 and O-68.

Within the ternary mixtures of table 3, the following mixtures are especially preferred according to the present invention: O-1, O-2, O-3, O-4, O-5, O-29, O-30, O-31, O-32 and O-33.

Within the ternary mixtures of table 3, the following mixture is utmost preferred according to the present invention: O-1.

According to one embodiment of the invention, the mixture applied in step b) of the method according to the invention, comprises at least two compounds (A) and at least one compound (B) selected from boscalid, dimoxystrobin, difenoconazole, prothioconazole, prochloraz, thiophanat-methyl and iprodione.

The mixtures disclosed in tables 1, 2 and 3 are also a further embodiment of the present invention.

In one embodiment of the method according to the invention, the seed of the crops requiring vernalization is treated with at least one compound (C) selected from N-(3′,4′,5′-trifluorobiphenyl-2-yl)-3-difluoromethyl-1-methyl-1H-pyrazole-4-carboxamide (common name: fluxapyroxad), N-[2-(4′-trifluoromethylthio)-biphenyl]-3-difluoromethyl-1-methyl-1H-pyrazole-4-carboxamide, N-(3′,4′-dichloro-5-fluorobiphenyl-2-yl)-3-difluoromethyl-1-methylpyrazole-4-carboxamide (common name: bixafen), N-[2-(1,3-dimethylbutyl)-phenyl]-1,3-dimethyl-5-fluoro-1H-pyrazole-4-carboxamide, N-(2-bicyclopropyl-2-yl-phenyl)-3-difluoromethyl-1-methyl-1H-pyrazole-4-carboxamide (common name: sedaxane), N-[1,2,3,4-tetrahydro-9-(1-methylethyl)-1,4-methanonaphthalen-5-yl]-3-(difluoromethyl)-1-methyl-1H-pyrazole-4-carboxamide (common name: isopyrazam) and N-[2-(1,3-dimethylbutyl)-3-thienyl]-1-methyl-3-(trifluoromethyl)-1H-pyrazole-4-carboxamide (common name: penthiopyrad), boscalid, dimethomorph (DMM) and metconazole before seeded according to step a).

Preferably, compound (C) is selected from the group consisting of bixafen, N-(3′,4′,5′-trifluorobiphenyl-2-yl)-3-difluoromethyl-1-methyl-1H-pyrazole-4-carboxamide, boscalid, dimethomorph (DMM) and metconazole.

More preferably, compound (C) is selected from the group consisting of boscalid, dimethomorph (DMM) and metconazole.

Most preferably, compound (C) is dimethomorph (DMM).

In the terms of the present invention “mixture” is not restricted to a physical mixture comprising at least two compounds (A) but refers to any preparation form of compound (A), the use of which is time- and locus-related.

In one embodiment of the invention “mixture” refers to a physical mixture of two compounds (A).

In another embodiment of the invention, “mixture” refers to ternary mixtures comprising three compounds (A).

In another embodiment of the invention, “mixture” refers to at least two compounds (A), each compound formulated separately but applied to the same plant in a temporal relationship, i.e. simultaneously or subsequently, the subsequent application having a time interval which allows a combined action of the compounds.

In another embodiment of the invention, at least one compound (C) is applied to the plant propagules.

In another embodiment of the invention, at least two compounds (C) are applied simultaneously, either as a mixture or separately, or subsequently to the plant propagules.

Furthermore, the individual compounds of the mixtures according to the invention such as parts of a kit or parts of the binary mixture may be mixed by the user himself in a spray tank and further auxiliaries may be added, if appropriate (tank mix). This applies also in case ternary mixtures are used according to the invention.

The plants to be treated according to the invention are plants needing vernalization during their vegetation cycle. Those plants are generally plants of economic importance and/or men-grown plants. Thus, they are preferably selected from agricultural, silvicultural and ornamental plants, more preferably from agricultural plants.

In one embodiment, the agricultural plant needing vernalization and which is treated according to the invention is selected from winter wheat, winter triticale, winter barley, winter rye, winter oat, winter oilseed rape and winter sugar beet.

In a preferred embodiment, the agricultural plant needing vernalization and which is treated according to the invention is selected from winter wheat, winter barley, winter rye, winter oilseed rape and winter sugar beet.

In a more preferred embodiment, the agricultural plant needing vernalization and which is treated according to the invention is selected from winter wheat, winter barley, winter oilseed rape and winter sugar beet.

In an even more preferred embodiment, the agricultural plant needing vernalization and which is treated according to the invention is winter oilseed rape.

In another embodiment, the agricultural plant needing vernalization and which is treated according to the invention is selected from hybrid varieties of winter wheat, winter triticale, winter barley, winter rye, winter oat, winter oilseed rape and winter sugar beet.

In a preferred embodiment, the agricultural plant needing vernalization and which is treated according to the invention is a hybrid variety of winter oilseed rape.

The preferred plants mentioned herein (such as winter oilseed rape and winter sugarbeet) can be a non-transgenic plant, e.g. as obtained by traditional breeding or through mutagenesis, or a transgenic plant carrying at least one transgenic event. In one embodiment it is preferred that the plant be a transgenic plant preferably carrying a transgenic event that confers resistance to a pesticide against the herbicides glyphosate or gluphosinate. In am more preferred embodiment of the invention, the transgenic plant carries at least one transgenic event that provides glyphosate resistance. More preferably, the transgenic plant is a “Roundup-Ready” (RR) winter oilseed rape or winter sugarbeet plant (available from Monsanto Company, St. Louis, Mo.) or a gluphosinate resistant winter oilseed rape or a imidazolinone-tolerant winter oilseed rape.

In the terms of the present invention, “agriculturally useful salts” are especially those cations and anions which do not have any adverse effect on the action of the compounds according to the invention such as a) suitable cations, which are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH⁴⁺) and substituted ammonium in which one to four of the hydrogen atoms are replaced by C1-C4-alkyl, C1-C4-hydroxyalkyl, C1-C4-alkoxy, C1-C4-alkoxy-C1-C4-alkyl, hydroxy-C1-C4-alkoxy-C1-C4-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethyhammonium, bis(2-hydroxyethyl)ammonium, benzyltrimethylammonium and benzyltriethylammonium, furthermore phosphonium ions, sulfonium ions, preferably tri(C1-C4-alkyl)sulfonium, and sulfoxonium ions, preferably tri(C1-C4-alkyl)sulfoxonium as well as b) suitable anions of useful acid addition salts, which are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C1-C4-alkanoic acids, preferably formiate, acetate, propionate and butyrate.

The term “agricultural plants” is to be understood as plants of which a part (e.g. seeds) or all is harvested or cultivated on a commercial scale or which serve as an important source of feed, food, fibres (e.g. cotton, linen), chemical processes (oil, sugar), combustibles (e.g. wood, bio ethanol, biodiesel, biomass) or other chemical compounds. Agricultural plants may also include horticultural plants, i.e. plants grown in gardens (and not on fields), such as certain fruits and vegetables. Preferred agricultural plants are for example cereals, e.g. wheat, rye, barley, triticale, oats, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fibre plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola (oils seed rape), sugar cane or oil palm, corn, tobacco, nuts, coffee, tea, bananas, vines (table grapes and grape juice grape vines), hop, turf, natural rubber plants or ornamental and forestry plants, such as flowers, shrubs, broad-leaved trees or evergreens (e.g. conifers) and on the plant propagation material, such as seeds, and the crop material of these plants.

The term “apical dominance” is the phenomenon whereby the main central stem of the plant is dominant over other side shoots.

The term “harvest security” is to be understood as an increased predictability and reliability of the final yield by controlling precisely the overall plant development throughout its vegetation cycle leading to plants that are optimal prepared to cope with adverse external factors such as weather (e.g. frost, drought), weeds, grasses, diseases (e.g. phytopathogenic fungi, insects, slugs) and reduced tillage, reducing the risk of a poor harvest or even crop loss. Another aspect of the term “harvest security” is directed to the possibility of increasing the influence on the harvest time point as well as its predictability and reliability which can be obtained by precisely controlling the plant development resulting in a reduced work load and more effective assignment (flexibility) of resources for the farmer. In yet another aspect, harvest security may result in increased quality of the harvested product such as a reduction of the level of impurities.

The term “impurity” (measured in %) is defined as everything which can be found in a harvest, which is not pure seed of the grown crop such as dust, remaining pods, other types of seed, straw and other plant parts.

The term “emergence” is defined as observable growth of the plant above the rooting medium surface (typically above soil surface).

The term “advanced seeding” or “earlier seeding” is defined as seeding of a crop variety before seeding of such crop variety is generally carried out in the respective area. Consequently, the term “advanced” and “earlier” is a relative term and depends on multiple parameters; especially on climatic conditions present in the respective area.

The term “germination” is defined as observable root growth development from the embryo.

The term “genetically modified plants” is to be understood as plants, which genetic material has been modified by the use of recombinant DNA techniques in a way that under natural circumstances it cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or farnesylated moieties or PEG moieties. Plants that have been modified by breeding, mutagenesis or genetic engineering, e. g. have been rendered tolerant to applications of specific classes of herbicides, such as hydroxyphenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A 242 236, EP-A 242 246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as 5-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP A 374 753, WO 93/007278, WO 95/34656, EPA 427 529, EP A 451 878, WO 03/18810 and WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nema-toda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e. g. Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP A 392 225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e. g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e. g. potatoes that produce increased amounts of amylopectin (e. g. Amflora® potato, BASF SE, Germany).

The term “location” is to be understood as any type of environment, soil, area or material where the plant is growing or intended to grow as well as the environmental conditions (such as temperature, water availability, radiation) that have an influence on the growth and development of the plant and/or its propagules.

In the terms of the present invention a “mixture” means a combination of at least two active ingredients.

The term “optimal seeding time point” is to be understood as the theoretically determined (calculated) optimal date for seeding of a certain crop variety, taking all external and internal factors into consideration, which typically have an influence on the plant's development and final yield. Even though, the optimal seeding time point depends on various parameters, the most crucial ones are the properties of the crop variety and the respective area where the plants are supposed to be grown. When the seeding time points are compared (e.g. whether they are early or late), one can only compare them within a certain region (respective area) and with respect to a crop variety (each variety having a specific optimal seeding time point).

Generally the term “plants” also includes plants which have been modified by breeding, mutagenesis or genetic engineering.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil.

The term “respective area” is to be understood as an area characterized by certain consistent parameters (e.g. a comparable climate, fauna and flora) of which many may have an impact on the growth and development of plants. Areas with continental climate for example, are generally determined by early starting, strong and long winters. On the other side, areas with a maritime climate are generally determined by late starting, mild and short winters.

The term “vernalization” is to be understood as the acquisition of the competence to flower and set seeds based on a period of low winter temperature to initiate or accelerate the flowering process, or, as the case with many fruit tree species, to actually break dormancy, prior to flowering. Many plant species and winter cereals such as wheat, must go through a prolonged period of cold before flowering occurs. Vernalization ensures that reproductive development and seed production occurs at the optimum environmentally favorable time, normally following the passing of winter. Vernalization activates a plant hormone called florigen present in the leaves which induces flowering at the end of the chilling treatment. Some plant species do not flower without vernalization. Many biennial species have a vernalization period, which can vary in period and temperature. Typical vernalization temperatures are between 5 and 10 degrees Celsius.

The term “winter cereals” is to be understood as cereals which are typically sown in late summer till late autumn. They germinate before winter, may partially grow during mild winters or simply persevere in a physiological dormant state to continue their vegetation cycle in spring. Winter forms are known for many important crops such as rye (winter rye/fall rye), wheat (winter wheat/fall wheat), barley (winter barley/fall barley) and triticale (winter triticale), oat (winter oat), oilseed rape (winter oilseed rape), sugar beet (winter sugar beet).

In one embodiment of the invention, the mixture, comprising at least two compounds (A), is applied in step b) at least once during the vegetation cycle of the crop.

In one embodiment of the invention, the mixture, comprising at least two compounds (A), is applied in step b) at least twice during the vegetation cycle of the crop.

In one embodiment of the invention, the mixture, comprising at least two compounds (A), is applied one to three times prior to the start of winter, preferably two times, most preferable one time.

In one embodiment of the method according to the invention, seeding of a crop variety according to step a) is carried out one to three weeks before the seeding of such crop variety is generally carried out in the respective area.

Applications of the respective mixture may also be necessary in the second year of the vegetation cycle (following the winter period) for example to overrule the apical dominance of the main shoot resulting in a stronger growth of the side shoots.

Accordingly, in another embodiment of the invention, the mixture, comprising at least two compounds (A), is applied one to three times prior to winter followed by one to two applications following the respective winter.

In yet another embodiment of the invention, the mixture, comprising at least two compounds (A), is applied once prior to winter followed by a single application following the respective winter.

In another embodiment of the invention, the mixture, comprising at least two compounds (A), is applied twice prior to winter followed by one to two applications following the respective winter.

In another embodiment of the invention, the mixture, comprising at least two compounds (A), is applied three times prior to winter followed by one to two applications following the respective winter.

Generally, the application time point depends on various factors such as the weather conditions, disease pressure, growth stage, developmental status, plant species, the specific plant variety and/or the work load of the farmer. Consequently, the application time point may vary depending on the factors listed above.

When applying the mixture according to the invention is used in the method according to the invention, the plants are preferably treated simultaneously (together or separately) or subsequently with at least two compounds (A).

Of course, the subsequent or sequential application is carried out with a time interval which allows a combined action of the applied compounds. Preferably, the time interval for a subsequent application of one compound (A) and a second compound (A) ranges from a few seconds up to 4 months, preferably, from a few seconds up to 3 months, more preferably from a few seconds up to 2 months, even more preferably from a few seconds up to 1 month, even more preferably from a few seconds up to two weeks, even more preferably from a few seconds up to 3 days, and in particular from 1 second up to 24 hours.

Most preferred is the joint application of one compound (A) and a second compound (A).

Herein, we have found that simultaneous, that is joint or separate, application of at least two compounds (A) or successive application of at least two compounds (A) in combination with an advanced seeding of a crop variety before seeding of such crop variety is generally carried out in the respective area, results in an enhanced harvest security.

In one embodiment according to the method of the invention, the mixture comprising at least two compounds (A) is applied in step b) as foliar application.

In one embodiment, the seed of the crops needing vernalization and which are seeded before seeding is generally carried out in the respective area is treated with at least one compound (B).

As a matter of course, the mixtures comprising at least two compounds (A) are employed in an effective and non-phytotoxic amount. This means that they are used in a quantity which allows to obtain the desired effect but which does not give rise to any phytotoxic symptoms on the treated plant or on the plant raised from the treated propagule or treated soil.

In the method according to the invention, the application rates of each compound (A) according to the invention are from 0.001 to 2.5 kg/ha per application, preferably 0.005 to 1.75 kg/ha per application, more preferably from 0.010 to 1.0 kg/ha per application depending on the type of compound and the desired effect.

In one embodiment according to the invention, a splitting of the optimal use rate over two or three fractions is carried out.

In the treatment of plant propagules, preferably seed, application rates of compound (B) are generally from 0.001 to 10000 g per 200 kg of plant propagules, preferably seed, preferably from 0.001 to 3000 g per 200 kg, in particular from 0.01 g to 2000 g per 200 kg of plant propagules, preferably seed.

In all mixtures used according to the method of the present invention, the compounds (A) are employed in amounts sufficient to enhance harvest security of crops needing vernalization. The weight ratio of the first compound (A1) to a second compound (A2), is preferably from 200:1 to 1:200, more preferably from 100:1 to 1:100, more preferably from 50:1 to 1:50 and in particular from 20:1 to 1:20. The utmost preferred ratio is 1:10 to 10:1. The weight ratio refers to the total weight of compounds (A1) and compounds (A2) in the mixture.

In a preferred embodiment, the mixture comprises mepiquat-chloride as compound (A1) and metconazole as compound (A2) in a weight ratio from 7:1.

The compounds according to the invention can be present in different crystal modifications whose biological activity may differ. They are likewise subject matter of the present invention.

Plant propagation materials may be treated with compounds (C) as such or a composition comprising at least one compound (C) prophylactically either at or before planting or transplanting.

The invention also relates to agrochemical compositions comprising a solvent or solid carrier and at least one compound according to the invention and to the use for enhancing harvest security of crops needing vernalization.

The compounds according to the invention, their N-oxides and salts can be converted into customary types of agrochemical compositions, e.g. solutions, emulsions, suspensions, dusts, powders, pastes and granules. The composition type depends on the particular intended purpose; in each case, it should ensure a fine and uniform distribution of the compound according to the invention.

Examples for composition types are suspensions (SC, OD, FS), emulsifiable concentrates (EC), emulsions (EW, EO, ES), microemulsions (ME), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF). Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 und ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e. g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e. g. amines such as N-methylpyrrolidone. Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e. g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan). Powders, materials for spreading and dusts can be prepared by mixing or concomitantly grinding the compounds I and, if appropriate, further active substances, with at least one solid carrier. Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g. ammonium sulfate, ammonium phosphate, ammonium nitrate, ureas, and products of vegetable origin, such as cereal meal, tree bark meal, wood meal and nutshell meal, cellulose powders and other solid carriers.

Examples for composition types are:

1. Composition Types for Dilution with Water

i) Water-Soluble Concentrates (SL, LS)

10 parts by weight of a compound I according to the invention are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.

ii) Dispersible Concentrates (DC)

20 parts by weight of a compound I according to the invention are dissolved in 70 parts by weight of cyclohexanone with addition of 10 parts by weight of a dispersant, e.g. polyvinylpyrrolidone. Dilution with water gives a dispersion. The active substance content is 20% by weight.

iii) Emulsifiable Concentrates (EC)

15 parts by weight of a compound I according to the invention are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

iv) Emulsions (EW, EO, ES)

25 parts by weight of a compound I according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

v) Suspensions (SC, OD, FS)

In an agitated ball mill, 20 parts by weight of a compound I according to the invention are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-Dispersible Granules and Water-Soluble Granules (WG, SG)

50 parts by weight of a compound I according to the invention are ground finely with addition of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-Dispersible Powders and Water-Soluble Powders (WP, SP, SS, WS)

75 parts by weight of a compound I according to the invention are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of a compound I according to the invention are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition Types to be Applied Undiluted

ix) Dustable Powders (DP, DS)

5 parts by weight of a compound I according to the invention are ground finely and mixed intimately with 95 parts by weight of finely divided kaolin. This gives a dustable composition having an active substance content of 5% by weight.

x) Granules (GR, FG, GG, MG)

0.5 parts by weight of a compound I according to the invention is ground finely and associated with 99.5 parts by weight of carriers. Current methods are extrusion, spray-drying or the fluidized bed. This gives granules to be applied undiluted having an active substance content of 0.5% by weight.

xi) ULV Solutions (UL)

10 parts by weight of a compound I according to the invention are dissolved in 90 parts by weight of an organic solvent, e.g. xylene. This gives a composition to be applied undiluted having an active substance content of 10% by weight.

The agrochemical compositions generally comprise between 0.01 and 95%, preferably between 0.1 and 90%, most preferably between 0.5 and 90%, by weight of active substance. The active substances are employed in a purity of from 90% to 100%, preferably from 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting, soaking and in-furrow application methods of the propagation material. In a preferred embodiment, the compounds or the compositions thereof, respectively, are applied on to the plant propagation material by a method such that germination is not induced, e. g. by seed dressing, pelleting, coating and dusting.

In a preferred embodiment, a suspension-type (FS) composition is used for seed treatment. Typically, a FS composition may comprise 1-800 g/l of active substance, 1 200 g/l surfactant, 0 to 200 g/l antifreezing agent, 0 to 400 g/l of binder, 0 to 200 g/l of a pigment and up to 1 liter of a solvent, preferably water.

The active substances can be used as such or in the form of their compositions, e. g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e.g. Pluronic RPE 2035® and Genapol B®; alcohol ethoxylates such as Lutensol XP 80®; and dioctyl sulfosuccinate sodium such as Leophen RA®.

The compositions according to the invention can also be present together with other active substances, e.g. with herbicides, insecticides, growth regulators, fungicides or else with fertilizers, as pre-mix or, if appropriate, not until immediately prior to use (tank mix).

The following examples are intended to illustrate the invention, but without imposing any limitation.

### EXAMPLES

Two field experiments were carried out under comparable growing conditions in the same growing area in Germany in the year 2009. Two oilseed rape varieties and two different seeding times were used. The first variety chosen was an open-pollinated variety called “Lorenz”; the second variety was a hybrid variety called “Excalibur”. With respect to the seeding times of the respective oilseed rape seeds, an early seeding time (=ES) and a later seeding time (=LS) were utilized. As a treatment, the commercially available product Carax® was applied twice during the growing season. Carax® comprises the active ingredients mepiquat chloride (210 g/l)+metconazol (30 g/l). The experimental set up was a standard randomized trial layout with 4 replicates. The first treatment was carried out in autumn of the year in which seeding took place followed by the same treatment in the spring of the following year. The use rate of Carax® (mepiquat chloride+metconazol) was 1 l/ha in each treatment. The products were first diluted in water and then added into the spray tank according Good Experimental Practice for field trials. Consequently, the composition were applied by a knapsack sprayer. A cover spray with a broad spectrum fungicide was made at flowering in addition to an insecticidal treatment to keep the experiments free from diseases. Standard assessments off the effects based on the treatment with Carax® versus Untreated were prepared starting from emergence up to the final harvest according the European Plant Protection Organization (EPPO) guidelines.

Table 4, 5 and 6 clearly demonstrate the increased harvest security based on an early seeding and the following Carax® treatment according to the method of the invention.

TABLE 4
Yield results are expressed as ton per ha oilseed rape seed.

| | Open Pollinated Variety | | | Hybrid Variety | | |
|---|---|---|---|---|---|---|
| | “Lorenz” | | | “Excalibur” | | |
| | | | Yield benefit | | | Yield benefit |
| | | | of CX | | | of CX |
| | UT | CX | (relative) | UT | CX | (relative) |
| Early Seeding | 5.47 | 5.89 | +8% | 5.74 | 6.24 | +9% |
| Late Seeding | 5.84 | 5.72 | −2% | 4.91 | 5.89 | +20% |
| Yield benefit | −7% | +3% | | +14% | +6% | |
| of ES | | | | | | |
| (relative) | | | | | | |

The yield benefit of plants treated with Carax ® (CX) versus untreated (UT) plants as well as Early Seeding (ES) versus Late Seeding (LS) is expressed in percent (%).

Compared to the untreated plants (UT), the plots derived from plants that were early seeded (ES) and additionally treated with Carax® (CX) showed in both field experiments a strongly increased yield (5.89 vs. 5.47 (“Lorenz”) and 6.24 vs. 5.74 “Excalibur”, respectively). In addition, the yield was also increased when Carax® was applied comparing the plots in which Early Seeding (ES) was carried out vs. the plots in which Late Seeding (LS) was carried out (5.89 vs. 5.72 (“Lorenz”) and 6.24 vs. 5.89 “Excalibur”, respectively).

Noteworthy, comparing both seeding times, a yield benefit in the untreated (UT) plots could only be seen in the experiment with the hybrid variety “Excalibur” (5.74 vs. 4.91) while the yield decreased in the experiment in which the Open Pollinated Variety “Lorenz” was used (5.47 vs. 5.84). The absence of a yield benefit in the earlier seeding time with the open-pollinated variety “Lorenz” can be explained by the severe overgrowing of the oilseed rape plants before winter and subsequent loss of plants during winter as demonstrated in table 5. This effect is the natural consequence of early seeding without adequate control of overgrowing by applying a mixture (such as mepiquat chloride+metconazol) according to the invention (step b). This data impressively shows that only the combination of early seeding (step a) and the application of a mixture according to the invention (step b) is able to enhance the harvest security of crops needing vernalization.

TABLE 5
The height of oilseed rape plants (cm) as well as the number of plants
(per m²) before and after winter. The reduced loss in plants treated
with Carax ® (CX = mepiquat chloride + metconazol) versus
untreated (UT) is expressed in percent (%).

| | Open Pollinated | | Hybrid Variety | |
|---|---|---|---|---|
| | Variety “Lorenz” | | “Excalibur” | |
| | UT + ES | CX + ES | UT + ES | CX + ES |
| Height (cm) | | | | |
| Before winter | 30.5 | 19.8 | 34.0 | 20.5 |
| After winter | 165.5 | 148.5 | 170.8 | 151.8 |
| | (UT + LS before | | (UT + LS before | |
| | winter = 18 cm) | | winter = 19 cm) | |
| Number of plants | | | | |
| (per m²) | | | | |
| Before winter | 53.8 | 52.0 | 49.5 | 51.0 |
| After winter | 49.5 | 50.8 | 48.3 | 50.0 |
| Loss of plants due | 8.0% | 2.4% | 2.5% | 2.0% |
| to winter in % | | | | |

As can be derived from table 5, Carax® (mepiquat chloride+metconazol) was able to keep the early seeded oilseed rape variety “Lorenz” as well as the variety “Excalibur” short before the winter (19.8 cm vs. 30.5 cm and 20.5 cm vs. 34.0 cm, respectively) reaching similar values as plants that were late seeded and which were left untreated (19.0 cm and 18.0 cm height before winter). At this height no adverse effects such as overgrowing and frost damage of the oilseed rape occurred. As a result, very little loss in oilseed rape plants were monitored due to the impact of winter. As can also be seen in table 5 (lower part), combining early seeding with the application of Carax® (mepiquat chloride+metconazol) according to the present invention, results in a reduction of plants that are lost due to the impact of winter. The level of reduction in turn depends to a certain degree on the variety. A very strong reduction could for example be viewed when applying the method according to the invention to the variety “Lorenz” resulting in a reduced loss of plants due to winter from 8% (UT+ES) to as little as 2.4% (CX+ES). The percentage of lost plants due to winter was even less (only 2%) when the variety “Excalibur” was early seeded and treated with Carax® (mepiquat chloride+metconazol) according to the invention.

From the foregoing, it can therefore be concluded that when the method according to the invention is applied comprising a) advanced seeding of a crop variety before seeding of such crop variety is generally carried out in the respective area, and b) applying a mixture comprising at least two active compounds (A), successfully reduces overgrowing, potential frost damage and losses in plants during winter. Consequently, the method according to the invention surprisingly allows the oilseed rape grower to enhance his harvest security based for example on the reduced loss of plants finally resulting in an increased and especially more reliable yield even when early seeding was applied. The available data clearly show that the higher yield in the earlier seeding would not have been secured without the application of a mixture according to the invention (such as Carax®=mepiquat chloride+metconazol).

TABLE 6
Impurities (%) as an additional factor relevant with respect
to the harvest security (measured at harvest).

| Open-Pollinated variety | | | Hybrid variety | | |
|---|---|---|---|---|---|
| “Lorenz” | | | “Excalibur” | | |
| | | Improvement | | | Improvement |
| | | by T | | | by T |
| UT | CX | (relative) | UT | CX | (relative) |

Early Seeding

| | | | | | | |
|---|---|---|---|---|---|---|
| Impurities (%) | 2.65 | 2.17 | −18% | 3.34 | 2.17 | −35% |

Late Seeding

| | | | | | | |
|---|---|---|---|---|---|---|
| Impurities (%) | 4.6 | 3.21 | −30% | 4.72 | 4.91 | +4% |
| Improvement | −42% | −33% | | −29% | −56% | |
| by ES | | | | | | |
| (relative) | | | | | | |

T = Treatment (=CX)

Table 6 demonstrates the fraction of impurities (which should be as low as possible) as an additional factor relevant with respect to the harvest security. As can be derived from table 6, the application of a mixture (such as Carax®) according to the invention (step b) when early seeding was carried out (step a) results in a strong reduction of impurities ranging from −18% (UT vs. CX at ES; variety Lorenz) up to −35% (UT vs. CX at ES; variety Excalibur). Comparing early seeding with late seeding shows that early seeding always has a positive impact on the level of impurities. Surprisingly, when applying the method according to the invention comprising early seeding (step a) in combination with the application of a mixture according to the invention (step b) results in the strongest reduction of impurities. A level of 2.17% is remarkably low and results in a better and faster processing, less waste, a reduced risk of humidity and as a result in improved storage conditions, a reduction of transport cost, less price reduction, a preferred purchase in case of oversupply, increased quality when used as biofuel, etc. All these factors are part of the harvest security which is the result of the method according to the invention.

1-15. (canceled)

16. A method for enhancing harvest security of crops needing vernalization comprising the steps:
a) seeding a crop variety before seeding of the crop variety is generally carried out in a respective area, and
b) applying a mixture comprising at least two active compounds (A) selected from the group consisting of mepiquat chloride, chlormequat chloride, N,N-dimethylmorpholinium chloride, metconazole, tebuconazole, paclobutrazol, trinexapac and prohexadion or an agriculturally useful salt thereof to the seeded crop variety,
where the harvest security is enhanced.

17. The method of claim 16, where the mixture of active compounds (A) comprises mepiquat chloride and metconazole.

18. The method of claim 16, where the mixture further comprises at least one compound (B) selected from the group consisting of boscalid, dimoxystrobin, difenoconazole, prothioconazole, prochloraz, thiophanat-methyl and iprodione.

19. The method of claim 16, further comprising treating a seed of the crop variety before seeding with at least one compound (C) selected from the group consisting of N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, N-(3′,4′-dichloro-5-fluorobiphenyl-2-yl)-3-difluoromethyl-1-methylpyrazole-4-carboxamide, N-[2-(1,3-dimethylbutyl)-phenyl]-1,3-dimethyl-5-fluoro-1H-pyrazole-4-carboxamide, N-(2-bicyclopropyl-2-yl-phenyl)-3-difluoromethyl-1-methyl-1H-pyrazole-4-carboxamide, N-[1,2,3,4-tetrahydro-9-(1-methylethyl)-1,4-methanonaphthalen-5-yl]-3-(difluoromethyl)-1-methyl-1H-pyrazole-4-carboxamide and N-[2-(1,3-dimethylbutyl)-3-thienyl]-1-methyl-3-(trifluoromethyl)-1H-pyrazole-4-carboxamide, boscalid, dimethomorph (DMM) and metconazole.

20. The method according to claim 19, where the compound (C) is selected from the group consisting of N-(3′,4′,5′-trifluorobiphenyl-2-yl)-3-difluoromethyl-i-methyl-IH-pyrazole-4-carboxamide, boscalid, dimethomorph (DMM) and metconazole.

21. The method of claim 16, where the seeding is carried out one to three weeks before the seeding of the crop variety is generally carried out in the respective area.

22. The method of claim 20, where the seeding is carried out one to three weeks before the seeding of the crop variety is generally carried out in the respective area.

23. The method of claim 16, where the mixture of active compounds (A) is applied at least twice during the vegetation cycle of the crop.

24. The method of claim 21, where the mixture of active compounds (A) is applied at least twice during the vegetation cycle of the crop.

25. The method of claim 16, where the mixture of active compounds (A) is applied as foliar application.

26. The method of claim 21, where the mixture of active compounds (A) comprising at least two is applied as foliar application.

27. The method of claim 16, where the mixture of active compounds (A) is applied at an application rate of from 0.001 to 2.50 kg/ha per application for each of the individual compounds.

28. The method of claims 25, where the mixture of active compounds (A) is applied at an application rate of from 0.001 to 2.50 kg/ha per application for each of the individual compounds.

29. The method of 16, where the crop variety is selected from winter wheat, winter triticale, winter barley, winter rye, winter oat, winter oilseed rape and winter sugar beet.

30. The method of claim 29, where the crop variety is winter oilseed rape.

31. The method of 28, where the crop variety is selected from winter wheat, winter triticale, winter barley, winter rye, winter oat, winter oilseed rape and winter sugar beet.

32. The method of claim 31, where the crop variety is winter oilseed rape.

33. The method of claim 16, where the enhancement of harvest security is manifested in an increased reliability of the expected yield.

34. The method of claim 16, where the enhancement of harvest security is manifested in a more predictable harvesting time point.
